(19) United States
(12) Patent Application Publication
(10) Pub. No.: US 2006/0007691 A1
(43) Pub. Date: Jan. 12, 2006

(54) Aerodynamic elliptical outdoor lighting support

(76) Inventors: Dennis Harold Depenbusch, Fort Worth, TX (US); Thomas Steven Lach, Colleyville, TX (US)

Correspondence Address: BLACKWELL SANDERS PEPER MARTIN LLP, 4801 Main Street, Suite 1000, KANSAS CITY, MO, 64112, US

(21) Appl. No.: 10/885,161

(22) Filed: Jul. 6, 2004

(51) Int. Cl. F21V 19/00

(52) U.S. Cl. 362/382

(57) ABSTRACT

An aerodynamic lighting support, having a center support and tubular cross arms with brackets for fastening a lighting fixture, is utilized to provide a lighting support that withstands wind forces better than traditional outdoor lighting supports. The tubular cross arms are substantially elliptical and provide greater stability without requiring larger or stronger materials.

### FIELD OF THE INVENTION

This invention relates to outdoor support structures and, more particularly, to structural supports for outdoor lighting applications.

### BACKGROUND OF THE INVENTION

Outdoor lighting supports, used to illuminate stadiums, parking lots, and roadways, have unique structural requirements due to their outdoor environment. Traditionally, the stability of an outdoor lighting support has depended on the strength and design of the materials used to construct the lighting support. One of the greatest considerations in the design of outdoor lighting supports is the application of wind load. Wind load puts increased pressure on the structural members of an outdoor lighting support structure.

In sports lighting applications, lighting fixtures are typically attached to either a steel or concrete center pole utilizing some type of horizontal support or maintenance workspace, often referred to as a cross arm or cage, respectively. These cross arms and cages are typically designed and constructed from structural steel members in the shape of angle iron, square or rectangular tubing, or pipe. These materials are commodity-type items readily available at any steel distribution center.

When designing steel poles for structural applications such as sports lighting, both dead loads (the weight of the lighting fixtures, brackets, pole, and any other appurtenances) and wind loads on these respective items are taken into consideration. One of the key goals in structural engineering is to maintain the structural integrity of the design while reducing the size, weight, and cost of the materials required for the design.

Increasing the strength/structural capacity of a central support pole or anchoring base to compensate for wind load will also increase costs. What is needed is a way to design a more wind-conscious light support without increasing materials costs.

Again, the standard structural shapes most commonly used for cross arms and cages have either flat sides (square or rectangular tubing and angle iron) or have a round cross-section (pipe). Each of these shapes has a theoretical value assigned to it from empirical data gathered from wind tunnel testing, which represents the amount of wind drag on the respective shape. These values are commonly referred to as drag coefficients. One of the industry-standard specifications, which outlines these drag coefficients, is the 2001 edition of the AASHTO (American Association of State Highway and Transportation Officials) publication “Standard Specifications for Structural Supports for Highway Signs, Luminaires and Traffic Signals.” This publication states that shapes with flat surfaces (tubing or angle) and shapes with round surfaces (pipe) have drag coefficients of 1.7 and 1.1 respectively. According to the publication, elliptical shapes have drag coefficients as low as 0.33, depending on the cross-sectional dimensions.

When designing objects which are subject to wind forces, one of the key components required in the design is the Effective Projected Area (EPA). The EPA is the actual projected area of an object multiplied by its respective drag coefficient; where the projected area of an object is equal to the width times the height of the respective object as projected in a plane perpendicular to the wind direction. Obviously, the less wind drag on an object, the less the EPA. The lower the EPA, the less structural capacity required to support the lighting fixtures and/or cross arms or cages. If an object has a higher EPA, it will require a stronger and more expensive design to support it.

### BRIEF SUMMARY OF THE INVENTION

There is, therefore, provided in the practice of the invention a novel aerodynamic elliptical outdoor lighting support, which has an elliptical or oval shaped vertical mast and horizontal cross arms, for improved aerodynamics, allowing the lighting support to better withstand high wind velocities. The aerodynamic lighting support broadly includes a support pole and either an oval vertical mast with oval cross arms or a cage with oval cross members.

In a preferred embodiment, the support pole is a vertical center support. The support pole may have a round, square, rectangular or oval cross section. The support pole has a connecting plate positioned at the top of the support pole. The vertical mast is substantially oval in shape and is fastened to the support pole by the connecting plate. The cross arm is positioned near the top of the vertical mast and substantially horizontal. The cross arm and the vertical mast are elliptical in shape, with the narrow end of the ellipses facing forward. The cross arm has fasteners for attaching lighting fixtures, speakers, or other equipment. Alternatively, the cage may be positioned atop the support pole and connected to the connecting plate. The cage has oval shaped horizontal and vertical bars and a platform.

Accordingly, it is an object of the present invention to provide an improved aerodynamic light support for superior wind resistance and structural integrity.

### BRIEF DESCRIPTION OF THE DRAWINGS

These and other inventive features, advantages, and objects will appear from the following Detailed Description when considered in connection with the accompanying drawings in which similar reference characters denote similar elements throughout the several views and wherein:

FIG. 1 is a front view of an aerodynamic elliptical outdoor lighting support according to the present invention;

FIG. 2 is a side view of the outdoor lighting support shown in FIG. 1;

FIG. 3 is top view of the outdoor lighting support shown in FIG. 1;

FIG. 4 is a fragmentary view of the vertical mast in FIGS. 1 and 2, taken from circle FIG. 2;

FIG. 5 is top view of an alternative embodiment of the outdoor lighting support with a cage;

FIG. 6 is a front view of the lighting support shown in FIG. 5; and

FIG. 7 is a side view of the lighting support shown in FIG. 5.

For the purpose of clarity in illustrating the characteristics of the present invention, accurate proportional relationships of the elements thereof have not been maintained in the Figures. Furthermore, the sizes of certain small devices and elements thereof have been exaggerated.

### DETAILED DESCRIPTION

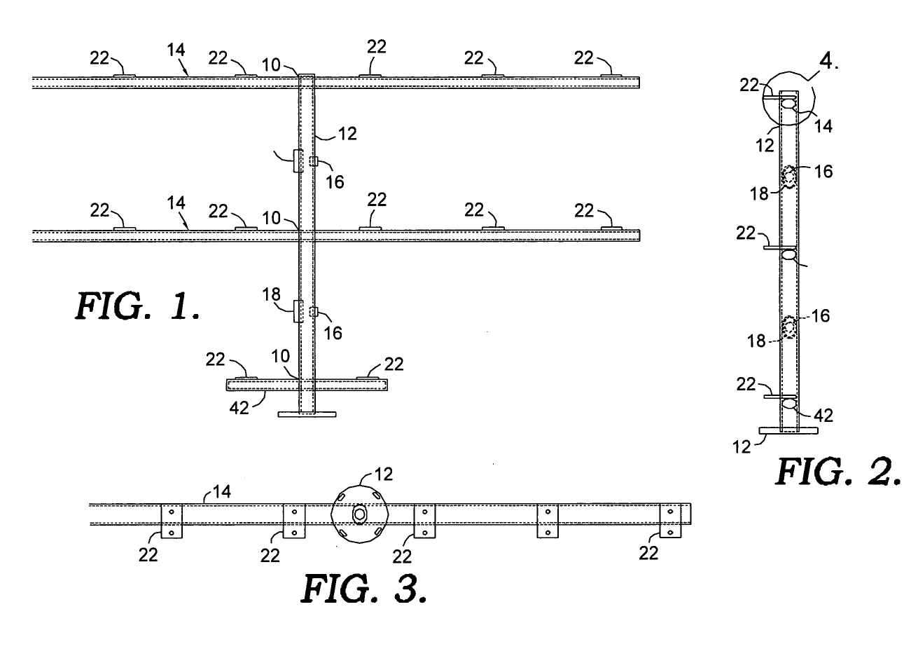

Referring to the drawings in greater detail, FIG. 1 shows an aerodynamic outdoor lighting support 20 constructed in accordance with a preferred embodiment of the present invention. The lighting support 20 broadly includes a support pole 8, a vertical mast 12 and at least one cross arm 14 attached to the vertical mast near the top of the vertical mast. The cross arm 14 is substantially elliptical or substantially oval in shape, providing decreased wind resistance, which results in a more stable lighting support 20. The cross arm 14 includes a bracket 28 for fastening a lighting fixture. The cross arm may also be an integral member of a cage 32 for securing the lighting fixtures to the lighting support 20, as shown in FIG. 5.

The support pole 8 is a substantially vertical center support that may be anchored to the ground by bolts, encased in a concrete base, or fastened by some other means. In one embodiment, the support pole has rungs 42 for climbing the pole to access the lighting fixtures or equipment. The support pole 8 can be rectangular, round or oval, although in a preferred embodiment the support pole is elliptical in cross-section. The support pole may also taper towards the top, getting smaller towards the top of the pole.

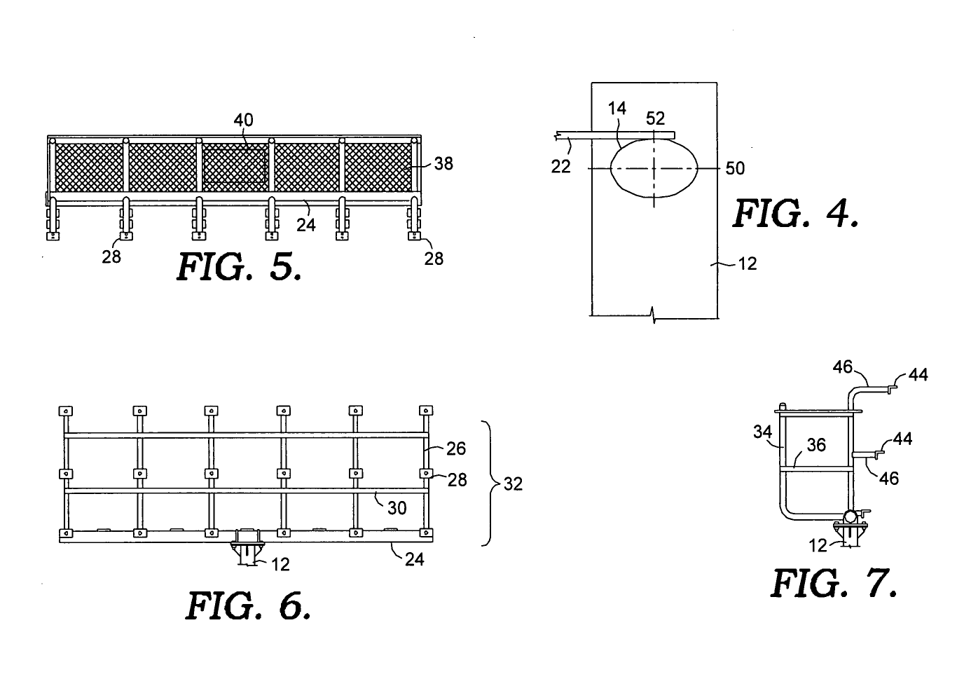

As shown in greater detail in FIG. 4, the vertical mast 12 is preferably hollow, substantially vertical and may be either oval or elliptical in shape. As shown in FIG. 4, elliptical, for the purpose of this invention, is defined as a shape with a minor axis 52 and a major axis 50, where the shape is defined by the standard equation x²/b²+y²/a²=1. The elliptical shape provides for decreased wind loads, which increases the stability of the lighting support 20 without increasing the weight or cost of the support overall. A substantially elliptical shape has a drag coefficient of approximately 0.33. For optimal wind tolerance, the major axis 50 is aligned with anticipated wind direction.

Oval, for the purpose of this invention, is identified as any elongated round shape, where the top and/or bottom of the shape may be partially flat and the sides are curved. Oval is defined to include elliptical shapes and other shapes that do not fit the definition given for elliptical in this application. Oval shapes would include an egg, a football, a racetrack or a rectangle with rounded corners, among other examples. A substantially oval shape has a drag coefficient in the range of approximately 0.29-0.81.

The vertical mast, in another embodiment, may be round or square in cross section. In an alternative embodiment, the vertical mast may taper towards the top of the mast, becoming more narrow near the top.

As shown in FIGS. 1 and 2, the vertical mast 12 typically has oval aperture 18, commonly referred to as a hand hole, and smaller, round aperture 16, commonly referred to as a coupling, for accessing electrical wires extending through the vertical mast 12. The apertures 18 and 16 may be capped to protect the internal electrical wires from weather damage.

Again referring to FIGS. 1 and 2, the cross arm 14 in a preferred embodiment is a hollow tube extending substantially perpendicular to the vertical mast 12. The cross arm is substantially elliptical or oval in shape with brackets 22 for attaching lighting fixtures, speakers, or other equipment. In a preferred embodiment, the drag coefficient is approximately 0.33. The cross arm is positioned so the vertical axis of the cross arm's cross-section is the shortest diameter, as shown in FIG. 2. The cross arm intersects the vertical mast 12 at apertures 10 and the cross arm extends through the vertical mast. The brackets 22, in one embodiment, are positioned on the top of the cross arm 14. The brackets may be bolted or welded to the cross arm. The lighting fixtures or speakers are usually attached to the brackets by bolts, but any fastening means would suffice.

In another embodiment, shown in FIGS. 5 and 6, the outdoor lighting support 20 has a cage 32. The cage 32 includes a work platform 38, horizontal cross members 30 and vertical cross members 26. Lighting fixtures, or other equipment, are attached to brackets 28. The cage 32 attaches to the support pole 8 with a connecting plate 6, which is welded to a main horizontal support member 24. The connecting plate 6 may also be fastened to the main horizontal support member 24 by other means.

As shown in FIG. 5, the platform 38 is substantially horizontal and constructed of wire mesh, although any sturdy material may be used for the platform. The platform 38 includes an opening 40 that allows a worker to access the cage and the equipment mounted on the cage. The horizontal support member 24 extends along the length of the platform 38 and the support pole 8 attaches to the platform at the horizontal support member 24. The support pole may be bolted or otherwise fastened to the horizontal support member, using the connecting plate 6.

As shown in FIG. 6, the vertical and horizontal cross members 26 and 30 form the “walls” of the cage 32. The vertical and horizontal cross members are elliptical or oval in shape when viewed in cross-section. This shape decreases the wind load and provides a more aerodynamic cage 32. Brackets 28 are mounted on the vertical cross members 26, although they may also be mounted on the horizontal cross members 30. It is preferred, though not required, that brackets 28 not be placed at the intersection of cross members 26 and 30, because such positioning will increase stress at these points and may result in premature damage to the cage 32.

As shown in FIG. 7, the cage 32 includes horizontal cross members 36 and perimeter bar 34. Both horizontal cross members 36 and perimeter bar 34 may be oval in cross-section, although elliptical is recommended. As in the previous embodiment, brackets for mounting equipment may be placed on either the horizontal cross member 36 or the perimeter bar 34. In one embodiment, the brackets 44 are positioned on mounting bars 46. The mounting bars may likewise be elliptical or oval in shape to reduce wind load.

The light support 20 according to the present invention provides less wind resistance, which reduces wind load and makes for a more stable lighting support. The aerodynamic design of the cross arms minimizes the effects of wind on the stability of the lighting supports. This improved stability results in a smaller lighting support that costs less to produce. The support pole, mast and cross arms do not need to be as large, so they are less expensive to fabricate.

Thus, an aerodynamic elliptical outdoor lighting support is disclosed which utilizes elliptical or oval cross arms to minimize the wind loads and thereby, provide a more stable lighting support that does not require increased material for greater stability. While preferred embodiments and particular applications of this invention have been shown and described, it is apparent to those skilled in the art that many other modifications and applications of this invention are possible without departing from the inventive concepts herein. For example, the vertical mast and cross arms may both be oval or elliptical, or only one of these two elements may be oval or elliptical, in accordance with the description provided above. It is, therefore, to be understood that, within the scope of the appended claims, this invention may be practiced otherwise than as specifically described, and the invention is not to be restricted except in the spirit of the appended claims. Though some of the features of the invention may be claimed in dependency, each feature has merit if used independently.

What is claimed is:

1. A lighting fixture support comprising:
a center support with a substantially oval shape; and
a substantially oval cross arm, attached to the support, the cross arm including brackets for mounting lighting fixtures or other equipment.

2. The lighting support according to claim 1, wherein the substantially oval shaped center support and cross arms have a drag coefficient of approximately 0.33.

3. The lighting support according to claim 1, wherein the center support has rungs for climbing the support to access the lighting fixtures.

4. The lighting support according to claim 1, wherein the center support includes an electrical wire extending up through the center support.

5. The lighting support according to claim 3, wherein the center support includes openings for accessing the electrical wiring.

6. A lighting fixture support comprising:
a hollow, substantially vertical support pole;
a cylindrical, substantially vertical mast, positioned atop the support pole; and
a substantially oval cross arm, attached to the vertical mast, the cross arm including brackets for mounting lighting fixtures or other equipment.

7. The lighting support according to claim 6, wherein the cross arm is elliptical.

8. The lighting support according to claim 7, wherein the cross arm has a coefficient of drag of approximately 0.33.

9. The lighting support of claim 6 wherein the vertical mast is fastened to the support pole by a connecting plate.

10. A lighting support comprising:
a tubular support pole with a substantially elliptical shape;
a cage for mounting lighting fixtures attached atop the support pole, the cage including a platform;
a substantially elliptical horizontal cross member;
a substantially elliptical vertical cross member; and
at least one bracket for mounting lighting fixtures or other equipment.

11. The lighting support according to claim 10 wherein the horizontal cross member has a drag coefficient of approximately 0.33.

12. The lighting support according to claim 10 wherein the vertical cross member has a drag coefficient of approximately 0.33.

13. The lighting support according to claim 10 wherein the platform includes a door for accessing the cage.

14. A lighting support comprising:
a tubular main support pole;
a cage for mounting lighting fixtures attached atop the main support pole, the cage including a platform;
a substantially oval, substantially horizontal cross member;
a substantially oval, substantially vertical cross member; and
a bracket for mounting lighting fixtures or other equipment.

15. The lighting support according to claim 14 wherein the horizontal cross member has a drag coefficient in the range of approximately 0.45-0.29.

16. The lighting support according to claim 14 wherein the vertical cross member has a drag coefficient in the range of approximately 0.45-0.29.

17. The lighting support according to claim 14 wherein the platform includes a door for accessing the cage.

18. A support comprising:
a substantially vertical center support that is oval in shape; and
a bracket for attaching a lighting fixture, speaker or other piece of equipment.

19. The support according to claim 18 wherein the center support is elliptical in shape.

20. The support according to claim 19 wherein the center support has a drag coefficient in the range of approximately 0.45-0.29.

21. The support according to claim 20 wherein the center support has a drag coefficient of approximately 0.33.

22. The support according to claim 18 wherein the support further includes a substantially horizontal cross arm that is oval in shape.
